(19) United States
(12) Patent Application Publication
(10) Pub. No.: US 2023/0407501 A1
(43) Pub. Date: Dec. 21, 2023

(54) APPARATUS FOR PRODUCTION OF HYDROGEN

(71) Applicant: KATHOLIEKE UNIVERSITEIT LEUVEN, Leuven (BE)

(72) Inventors: Johan MARTENS, Sint-Joris-Weert (BE); Jan RONGÉ, Overijse (BE); Tom BOSSEREZ, Humbeek (BE); Gino HEREMANS, Beverlee (BE); Christos TROMPOUKIS, Vorst (BE); Robin PEETERS, Heist-op-den-Berg (BE)

(21) Appl. No.: 18/247,502

(22) PCT Filed: Oct. 4, 2021
(86) PCT No.: PCT/EP2021/077315

§ 371 Date: Mar. 31, 2023

(30) Foreign Application Priority Data
Oct. 2, 2020 (EP) 20199917.4

(51) Int. Cl. C25B 13/08; C25B 1/042; C25B 15/023; C25B 15/08

(52) U.S. Cl. CPC C25B 13/08; C25B 1/042; C25B 15/087; C25B 15/08; C25B 15/023

(57) ABSTRACT

The invention relates to a hydrogen producing apparatus comprising an enclosed volume, the volume comprising: at least one gas inlet from the outside environment, at least one porous matrix material with hygroscopic or deliquescent properties and having ionic conductivity, an oxygen producing electrode, a hydrogen producing electrode, an optional separator positioned between the oxygen producing electrode and the hydrogen producing electrode, a connection for connecting the electrodes to a power source, and at least one outlet for collecting the produced hydrogen outside the hydrogen producing apparatus, wherein a porous matrix material is in contact with the oxygen producing electrode.

### FIELD OF THE INVENTION

The present invention relates generally to the field of vapour phase water electrolysis.

### BACKGROUND OF THE INVENTION

Electrolysis of liquid water to produce hydrogen and oxygen gas is a well-known technology. An electrolyser comprises electrocatalysts at the anode and the cathode compartment, and a separator to divide the compartments. Alkaline electrolysis technology utilizes a continuous alkaline aqueous phase, with a porous separator between anode and cathode electrodes. In polymer electrolyte membrane (PEM) electrolysis, pure water is fed and the electrodes are separated by a polymer membrane.

Generally, the electrodes are flanking the membrane in a MEA (membrane electrode assembly). The anode is provided with electrocatalyst to perform the oxygen evolution reaction (OER). The cathode is provided with another type of electrocatalyst to perform the hydrogen evolution reaction (HER).

A membrane is a semi-permeable selective barrier for molecules, ions and small particles. Membranes are classified into three categories: microfiltration, ultrafiltration and nanofiltration. Respectively these membranes remove components from 5-80 nm, 2-5 nm and <2 nm.

In such liquid-fed electrolysers, the membrane essentially assumes two functions: (i) it serves as solid electrolyte and enables ions to permeate and (ii), it separates the hydrogen and oxygen gases produced at the cathode and the anode, respectively; in two separate streams.

In order to serve as a solid ion exchange electrolyte, membranes are typically grafted with immobile charged anionic groups, such as perfluorinated polyethylene with sulfonic acid functional groups. This allows protons to migrate from anode to cathode while anions are blocked. Energy losses in such devices are largely impacted by Ohmic resistances. In a membrane the Ohmic resistance is linearly related to the membrane thickness and the device current density. Thin membranes are targeted in order to minimize the energy losses.

The second function of the membrane is to prevent the mixing of hydrogen and oxygen gas and enables the collection of the two product gases separately, from cathode and anode compartment, respectively. Undesired cross-over of the gases is caused by diffusional transport of the gas molecules through the membrane.

The flux of gas molecules through a membrane is governed by the permeability of the gas molecules and the concentration gradient across the membrane. The permeability is primarily determined by the pore diameter. Diffusion of H₂ and O₂ molecules through the membrane is limited by the narrow channels of typically 10 Å (1 nm) in diameter.

The gradient driving the gas permeation through the membrane is determined by the partial pressure difference of the gas at the two sides of the membrane and the membrane thickness. Diffusional resistance is increased and cross over limited by narrowing the pores, thus preventing the need for thick membranes (which would lead to large Ohmic resistance losses).

Overall a compromise has to be reached concerning the optimum membrane thickness to limit Ohmic losses and cross-over of gases. The current art allows for membrane thickness as low as 20 μm while still providing sufficient gas barrier function [Carmo et al. (2013) Int. J. Hydrogen Energy, 38(12), 4901-4934]. Electrolysers fed with electricity from the grid have compact mass-volume characteristics. They are operated at high electric current density (1 A/cm² and higher) to enhance the productivity per volume. Ohmic losses scale linearly with current density, driving the technology to membranes that are as thin as possible. Water electrolysis can also be performed with cathode and anode compartment filled with vapour instead of aqueous solution. Water molecules to be split are fed as water vapour contained in a gaseous stream, typically air. In that application, membrane electrode assemblies are used as well, with the membrane serving the same functions as in liquid phase electrolysers. It serves as a solid electrolyte and as a barrier for preventing cross-over of H₂ and O₂ molecules.

Moreover, the water management of the membrane is very critical in vapour-fed applications. When the water vapour content of the gas in the reaction chamber is low, the membrane is dehydrated compromising its proper functioning. More precisely, dehydration causes an increase, usually exponential increase, of specific Ohmic resistance with concomitant increase of energy losses. These disadvantages are described in WO2012135862.

The water adsorption capacity of membranes used in electrolysers is typically less than 40 wt. %. A 20 μm membrane thus contains only ca. 1.6 mg water per cm² and is rapidly dehydrated during electrolysis which consumes water molecules. Vapour-fed electrolysers typically operate at current densities ranging between 10-100 mA/cm², corresponding to a consumption of 3-34 mg H₂O per cm² per hour. To keep the membrane fully hydrated at all times, continuous close matching of water consumption and supply is necessary in such a system. This can be achieved by increasing the flow rate of inlet feeds, and by maintaining a very high relative humidity of the inlet feeds [Spurgeon & Lewis (2011) Energy Environ. Sci. 4(8), 2993-2998; Kumari et al. (2016). Energy Environ. Sci. 9, 1725-1733; Modestino et al. (2015) Lab Chip 15, 2287-2296].

In patent application [WO2017190202] it is claimed to use a spatially separated inorganic adsorbent material which is trapping water from ambient air, and which is delivering water to the MEA by thermal desorption. Heat is provided by the sun and heat management in the device. This alleviates the need to perfectly match water consumption and supply.

### SUMMARY OF THE INVENTION

The present invention relates to the field of vapour phase water electrolysis, and in particular, to an improvement thereof by storing water vapour captured from a gaseous stream in a porous matrix material. The system may further be engaged with photovoltaic (PV) systems to obtain a self-contained system producing hydrogen from sunlight and water vapour.

The apparatus of this invention overcomes the limitations of MEAs by integrating a large volume porous matrix material, in direct contact with the MEA. The porous matrix material contains a hygroscopic or deliquescent material and serves a function which is enhanced compared to the membrane's functionality: (i) it is able to capture and store water and release it directly to the MEA when needed; (ii) it ensures ionic conductivity in order to maintain proper operation of the assembly; (iii) the liquid-filled pores prevent cross-over of gaseous products. As such, a buffered MEA (BMEA) is obtained. The porous matrix material may be water-sorbing and ion-conducting by its own properties, when it is made of a material having such properties, e.g. a polymer. It may alternatively contain additional materials such as a hygroscopic or deliquescent solute or an inorganic filler.

Whereas membranes are designed to be as thin as possible to reduce Ohmic resistance, while maintaining sufficient gas-blocking properties, a porous matrix material is designed to be as thick as necessary for water storage. Its thickness causes increased Ohmic resistance [Xiang et al. (2013) Energy & Environmental Science 6(I), 3713-3721; Berger et al. (2014) Energy & Environmental Science 7, 1468-1476]. However, at the current densities encountered in water vapour electrolysis devices, this is not prohibitive. For example, a porous matrix material filled with highly conducting liquid (e.g. 4 M KOH) achieves a conductivity of at least 100 mS cm⁻¹. For a thickness of 1000 μm, the resistance then is 1 Ωcm². To keep Ohmic losses below an acceptable value of 100 mV, the current density should then not surpass 100 mA cm⁻², which is more than the current densities typically encountered in vapour-fed electrolysis [Spurgeon & Lewis (2011) Energy Environ. Sci. 4(8), 2993-2998; Heremans et al. (2017) Sustainable Energy Fuels 1, 2061-2065].

The porous matrix material is an open-celled, highly porous material such as fibrous tissue or cloth, metallic foam, polymeric foam or synthetic sponge. The matrix typically has pores with diameters larger than 50 nm or larger than 10 nm and thus different from those characteristic of membranes.

To enable ionic conductivity, the porous matrix may contain a solute, consisting of a salt, an acid or a base to allow ions to be conducted through the body from one electrode to the other. In liquid water-fed devices, such solutes would migrate to the liquid feed and ionic conductivity of the MEA would deteriorate. Therefore, porous matrix materials are particularly suited to vapour-fed applications in which this issue is avoided.

Said solute is hygroscopic or deliquescent, and will absorb water so as to create a viscous or liquid electrolyte phase within the pore volume of the matrix. The cellular design of the matrix is such that volumetric changes due to water usage for water splitting do not interrupt the electrolyte continuum needed for maintaining ionic contact and for preventing H₂ and O₂ cross-over. The continuum is maintained by percolation and volumetric contraction and expansion of the matrix. Water transport and permeation throughout the material is warranted by its open-celled structure. Preferably, the capillary forces and the viscosity of the electrolyte are such that the liquid cannot leak out of the porous matrix material. A particular advantage of using a porous matrix material is that the water can be fed from ambient air or any other humid gaseous feed and that the pore volume by hygroscopic nature can serve as a water reservoir for feeding water molecules to the reaction chamber for performing the water splitting reactions. The choice of polymer or solute changes both the conductivity of the water body as well as the hygroscopic/deliquescent nature and water sorption characteristics of the water body and the amount of water that can be absorbed from a humid environment. The choice of solute, if any, may include, but is not restricted to: acids (e.g. H₂SO₄, H₃PO₄, HClO₄), bases (e.g. NaOH, KOH, LiOH, CsOH, Ca(OH)₂), salts with pH buffering properties (e.g. borates, phosphates, carbonates, citrates), salts with high water uptake (e.g. LiCl, CaCl₂), salts with specifically shaped water sorption isotherms (e.g. CH₃CO₂K, KHCO₂, C₃H₅KO₃).

Multiple solutes may be employed to obtain improved characteristics. Different solutes could have complementary water sorption properties, so as to achieve efficient water uptake under different circumstances. It is also possible to include one material with high ionic conductivity with another material having high water uptake. Furthermore, solutes can be chosen based on their pKₐ or their pH buffering properties. Solutes can also be added to change the viscoelastic properties of the electrolyte.

The porous matrix material is in direct contact with the other components of the BMEA. Moreover, the open and continuous pore network is filled with liquid water. Both aspects result in fast and efficient transfer of (liquid) water to and from the electrodes when needed. To enable effective water management, the electrodes are permeable to water as well.

The volume of water available for water splitting corresponds to the volumetric variation of the water body. Replenishment of the water body could be obtained by exposing the water body to ambient air at a relative humidity high enough to yield absorption by the water body. Contrary to membranes, a porous matrix material containing a solute maintains high ionic conductivity in a non-fully hydrated state. Mechanical integrity of the porous matrix material and assembly also comprising electrodes is maintained by the flexible nature of the matrix material, resulting in a BMEA that is able to shrink or expand.

The BMEA is particularly advantageous in a hydrogen producing apparatus which is powered with a photovoltaic device providing a limited current density, and in the range of 0-10 or 0-30 mA/cm², up to 100 mA/cm². The volume of water needed as feed for hydrogen and oxygen formation at a theoretical Faradaic efficiency of 100% is ca. 30-300 g/h·m². This amount of water can be provided by a water body with thickness ranging from 60-600 μm, which will undergo a shrinkage up to 50%. If the porous matrix material allows for a higher water uptake and/or more shrinkage, thickness can be reduced.

The BMEA can also be used as a strategy to allow for a 2-step process, in which the system is regenerated overnight with outside air. During daytime, the porous matrix material supplies all the needed water for hydrogen and oxygen production without requiring external water input. To prevent undesired evaporation of the water body, the gas inlet preferably is closed during daytime, and opened at night when relative humidity is higher than during daytime. This opening/closing is driven by a light, humidity or other sensor, connected to the device. The thickness of the matrix holding the water body can be adjusted to the water consumption such as to cover at least one day of operation, or any metric relevant for a specific climate, without feeding outside air to replenish the water body. At an insolation of 2-10 kWh m⁻² day⁻¹ and an energy conversion efficiency of 10-25%, ca. 0.05 up to 0.7 L water is required to sustain operation for a full day. This amount of water can be provided by a water body with thickness ranging from 100-1400 μm, which will undergo a shrinkage up to 50%. If thickness is increased, the area of the BMEA may be reduced.

The invention is summarized by the following statements:

1. A hydrogen producing apparatus comprising an enclosed volume, the volume comprising:
at least one gas inlet (1) from the outside environment;
at least one porous matrix material (2) with hygroscopic or deliquescent properties and having ionic conductivity, and optionally at least one separator (7);
an oxygen producing electrode (3) and a hydrogen producing electrode (4), positioned on opposite sides of said porous matrix material (2) or on opposite sides of said separator (7), thereby forming an assembly (5).
a connection for connecting the electrodes to a power source (5); and
at least one outlet for the produced hydrogen (6).

When there is no separator present, the porous matrix material is gas impermeable.

In specific embodiments the separator is gas-impermeable.

In specific embodiments wherein the inlet can be closed, an additional outlet is provided to allow the release of produced oxygen

2. The apparatus according to statement 1, wherein the porous matrix material (2) is positioned between an oxygen producing electrode (3) and a hydrogen producing electrode (4).

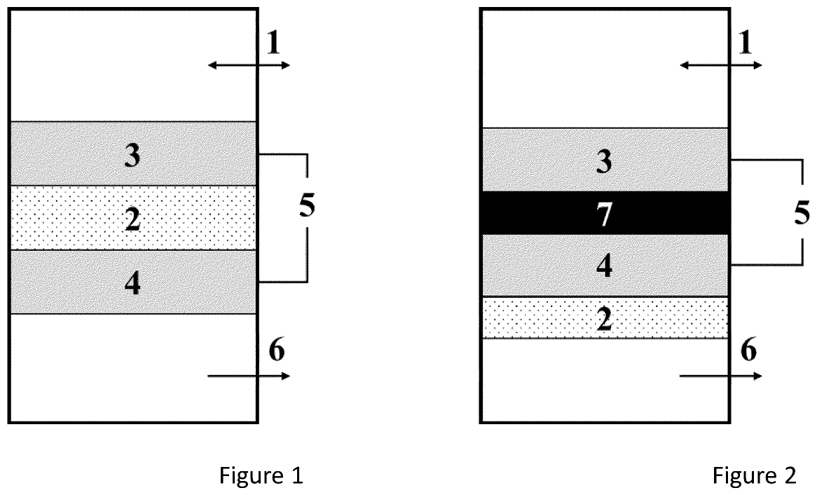

3. The apparatus according to statement 1 or 2, wherein a gas-impermeable separator (7) is absent in the enclosed volume. This embodiment is illustrated in FIG. 1.

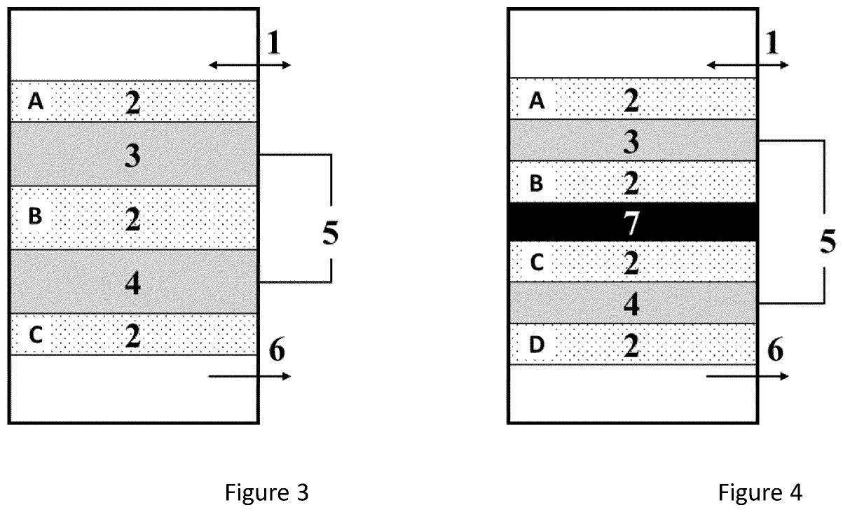

4. The apparatus according to statement 3, wherein in addition a further porous matrix material (2) is positioned at one or both outer sides of the assembly. This embodiment is illustrated in FIG. 3.

5. The apparatus according to statement 1, wherein a gas-impermeable separator (7) is positioned between an oxygen producing electrode (3) and a hydrogen producing electrode (4), and wherein a porous matrix material is positioned at one or both outer sides of the assembly This embodiment is illustrated in FIG. 2.

6. The apparatus according to statement 5, wherein a gas-impermeable separator (7) is positioned between an oxygen producing electrode (3) and a hydrogen producing electrode (4), and wherein a porous matrix material is positioned between the separator and the oxygen producing electrode (3) and/or between the separator and the an hydrogen producing electrode (4). This embodiment is illustrated in FIG. 1.

7. The apparatus according to statement 5 wherein in addition a further porous matrix material (2) is positioned at one or both outer sides of the assembly This embodiment is illustrated in FIG. 3).

8. The apparatus according to any one of statements 1, 2 and 5 to 7, whereby the gas-impermeable separator is a membrane.

9. The apparatus according to any one of statements 1 to 8, whereby the porous matrix material comprises one or more solutes providing hygroscopic, deliquescent and/or conductive properties.

10. The apparatus according to any one of statements 1 to 6 whereby the gas producing electrodes are connected directly to a device for solar energy conversion, such as a photovoltaic or photoelectrochemical device.

11. The apparatus according to any one of statements 1 to 10, whereby the porous matrix material contains pores having a diameter of at least 10 nm, at least 20 nm, at least 50 nm up to 1 mm.

12. The apparatus according to any one of statements 1 to 11, whereby the porous matrix material is a macroporous material.

13. The apparatus according to statement 8, whereby the porous matrix material comprises a liquid water volume containing said solute.

14. The apparatus according to any one of statements 1 to 13, whereby the porous matrix material is wholly or partially backfilled with a second matrix material or a polymer.

The apparatus according to any one of statements 1 to 14, whereby the porous matrix material has a thickness from at least 300 μm, or at least 500 μm up to 5 mm, 10 mm, 0.5 cm, 1 cm or 2 cm.

16. The apparatus according to any one of statements 1 to 15, whereby the porous matrix material is composed of a polymeric substance, such as cellulose, polyester, polyvinyl alcohol, polyimide, polyether imide, polyacryl amide, polybenzimidazole, polyaryl ether, polysulfone, polyether sulfone or a blend of multiple such materials.

17. The apparatus according to any one of statements 8 to 16, whereby the porous matrix material contains a hydrophilic polymer and the solute provides an ionic conductivity of at least 0.1 Siemens/m.

18. The apparatus according to any one of statements 8 to 17, whereby the porous matrix material contains fixed ionic charges such as sulfonic or quaternary ammonium groups, and the solute provides hygroscopic or deliquescent properties.

19. The apparatus according to any one of statements 8 to 18, whereby the solute is a strong deliquescent base (pKb <1), such as potassium hydroxide, sodium hydroxide, caesium hydroxide.

20. The apparatus according to any one of statements 8 to 19, whereby the solute is a salt with water uptake of at least 1 g water/g of salt at a water activity of 0.99 and room temperature, such as lithium chloride, sodium chloride, calcium chloride, calcium iodide, potassium nitrate, lithium nitrate, potassium acetate, sodium formate, sodium carbonate, potassium phosphate, potassium borate. Preferred salts are calcium chloride, potassium acetate, sodium formate and sodium citrate.

21. The apparatus according to any one of statements 8 to 20, whereby a mixture of different solutes is employed, to obtain enhanced hygroscopic, conductive or viscoelastic properties.

22. The apparatus according to any one of statements 1 to 21, whereby the porous matrix material contains non-dissolving substances with hygroscopic properties, such as mesoporous silica, metal organic framework or layered double hydroxide.

23. The apparatus according to any one of statements 1 to 22, whereby the gas entry can be opened or closed.

24. The apparatus according to any one of statements 1 to 24, whereby the gas entry is positioned at the oxygen producing electrode.

25. A method of producing hydrogen in an apparatus according to any one of statements 1 to 24, the method comprising the steps of:
allowing the entrance of an inlet gas comprising water via the gas entry, thereby regenerating the water content of the porous matrix material;
optionally closing the gas entry after regeneration of the porous matrix-material; and allowing conversion of electrical energy and water molecules into hydrogen and oxygen molecules on the cathode and anode, respectively.

26. The method according to statement 25, wherein the inlet gas is introduced by means of forced convection, such as by a pump or ventilator.

27. The method according to statement 25 or 26, wherein the gas entry is opened and closed by a light-sensitive sensor according to the diurnal cycle.

28. The method according to any one of statements 25 to 27, wherein the gas entry is opened and closed by a humidity-dependent sensor.

29. The method according to any one of statements 25 to 28, wherein the produced oxygen is removed.

30. The method according to any one of statements 25 to 29, wherein the produced oxygen is removed.

31. A hydrogen producing apparatus comprising an enclosed volume, the volume comprising:
at least one gas inlet (1) from the outside environment;
   at least one porous matrix material (2) with hygroscopic or deliquescent properties and having ionic conductivity,
an oxygen producing electrode s,
a hydrogen producing electrode (4), an optional separator (7) positioned between the oxygen producing electrode (3) and the hydrogen producing electrode (4),
a connection for connecting the electrodes to a power source (5), and
at least one outlet (6) for collecting the produced hydrogen outside the hydrogen producing apparatus,

wherein a porous matrix material (2) is in contact with the oxygen producing electrode (3).

32. The hydrogen producing apparatus according to statement 31, wherein said least one porous matrix material (2) has deliquescent properties.

33. The apparatus according to statement 32, wherein the separator (7) is absent and
a porous matrix material (2) is positioned between the at least one gas inlet (1) and the oxygen producing electrode (3) and/or
a porous matrix material (2) is positioned between the oxygen producing electrode (3) and the hydrogen producing electrode (4).

34. The apparatus according to statement 33, wherein
a porous matrix material (2) is positioned between the oxygen producing electrode (3) and the hydrogen producing electrode (4) and
a porous matrix material (2) is positioned between the at least one gas inlet (1) and the oxygen producing electrode (3).

35. The apparatus according to statement 33 or 34, wherein a further porous matrix material (2) is positioned between the hydrogen producing electrode (4) and the at least one outlet (6).

36. The apparatus according to statement 33 or 34, wherein
a porous matrix material (2) is absent between the at least one gas inlet (1) and the oxygen producing electrode (3) and
   a porous matrix material (2) is positioned between the oxygen producing electrode (3) and the hydrogen producing electrode (4) and
a porous matrix material (2) is absent between the hydrogen producing electrode (4) and the at least one outlet (6).

37. The apparatus according to any one of statements 33 to 35, wherein
a porous matrix material is positioned between the at least one gas inlet (1) and the oxygen producing electrode (3) and
   a porous matrix material (2) is positioned between the oxygen producing electrode (3) and the hydrogen producing electrode (4), and
a further porous matrix material is positioned between the hydrogen producing electrode (4) and the at least one outlet (6).

38. The apparatus according to statement 31 or 32, wherein a gas-impermeable separator (7) is present between the oxygen producing electrode (3) and the hydrogen producing electrode (4), and wherein
a porous matrix material (2) is positioned between the at least one inlet (1) an the oxygen producing electrode (3) and/or
a porous matrix material (2) is positioned between the oxygen producing electrode (3) and the separator (7).

39. The apparatus according to statement 38, wherein
a further porous matrix material is positioned between the separator (7) and the hydrogen producing electrode (4) and/or
a further porous matrix material is positioned the hydrogen producing electrode (4) and the at least one outlet (6).

40. The apparatus according to statement 38 or 39, wherein
a porous matrix material (2) is positioned between the at least one inlet (1) an the oxygen producing electrode (3)
a porous matrix material (2) is absent between the oxygen producing electrode (3) and the separator (7)
a porous matrix material (2) is absent between the separator (7) and the hydrogen producing electrode (4) and,
a further porous matrix material is positioned the hydrogen producing electrode (4) and the at least one outlet (6).

41. The apparatus according to statement 38 or 39, wherein
a porous matrix material (2) is absent between the at least one inlet (1) an the oxygen producing electrode (3),
   a porous matrix material (2) is positioned between the oxygen producing electrode (3) and the separator (7),
   a porous matrix material is positioned between the separator (7) and the hydrogen producing electrode (4) and,
   a porous matrix material (2) is absent between the hydrogen producing electrode (4) and the at least one outlet (6).

42. The apparatus according to statement 38, wherein
a porous matrix material (2) is absent between the at least one inlet (1) an the oxygen producing electrode (3),
   a porous matrix material (2) is positioned between the oxygen producing electrode (3) and the separator (7),
   a porous matrix material (2) is absent between the separator (7) and the hydrogen producing electrode (4) and,
   a porous matrix material (2) is absent the hydrogen producing electrode (4) and the at least one outlet (6).

43. The apparatus according to statement 38, wherein
a porous matrix material (2) is positioned between the at least one inlet (1) an the oxygen producing electrode (3),
a porous matrix material (2) is absent between the oxygen producing electrode (3) and the separator (7),
   a porous matrix material (2) is absent between the separator (7) and the hydrogen producing electrode (4) and,
   a porous matrix material (2) is absent between the hydrogen producing electrode (4) and the at least one outlet (6).

44. The apparatus according to statement 38 or 39, wherein
a porous matrix material (2) is positioned between the at least one inlet (1) an the oxygen producing electrode (3) and
   a porous matrix material (2) is positioned between the oxygen producing electrode (3) and the separator (7)
   a porous matrix material is positioned between the separator (7) and the hydrogen producing electrode (4) and
a porous matrix material is positioned the hydrogen producing electrode (4) and the at least one outlet (6).

45. The apparatus according to any one of statements 31, 32 and 38 to 44, wherein the gas-impermeable separator (7) is a membrane.

46. The apparatus according to any one of statements 31 to 45, whereby the porous matrix material (2) comprises one or more solutes providing hygroscopic, deliquescent and/or conductive properties.

47. The apparatus according to any one of statements 31 to 46 whereby the gas producing electrodes (3) and (4) are connected directly to a device for solar energy conversion, such as a photovoltaic or photoelectrochemical device.

48. The apparatus according to any one of statements 31 to 47, whereby the porous matrix material (2) contains pores having a diameter of at least 10 nm.

49. The apparatus according to any one of statements 31 to 48, whereby the porous matrix material (2) has a thickness from at least 300 μm.

50. The apparatus according to any one of statements 38 to 49, whereby the porous matrix material (2) contains a hydrophilic polymer and the solute provides an ionic conductivity of at least 0.1 Siemens/m.

51. A method of producing hydrogen in an apparatus according to any one of statements 31 to 50, the method comprising the steps of:
allowing the entrance of an inlet gas comprising water via the at least one gas inlet (1), thereby regenerating the water content of the porous matrix material (2);
optionally closing the at least one gas inlet (1) after regeneration of the porous matrix material (2);
and allowing conversion of electrical energy and water molecules into hydrogen and oxygen molecules on the cathode (4) and anode (3), respectively.

52. The method according to statement 51, further comprising the step of collecting the hydrogen being producing in the apparatus via the at least one outlet (6).

53. The method according to statement 51 or 52, wherein the gas entry is opened and closed by a light-sensitive sensor according to the diurnal cycle or by a humidity-dependent sensor.

### DETAILED DESCRIPTION

FIG. 1 shows an embodiment of the present invention. 1=gas entry; 2=porous matrix material; 3=oxygen producing electrode; 4=hydrogen producing electrode; 5=connection to a power source; 6=outlet for the produced hydrogen.

FIG. 2 shows an embodiment of the present invention containing a gas-impermeable separator. In this embodiment, the porous matrix material can be positioned at any chosen location in the assembly, as long as it is in direct contact with at least one electrode or the separator. 1=gas entry; 2=porous matrix material; 3=oxygen producing electrode; 4=hydrogen producing electrode; 5=connection to a power source; 6=outlet for the produced hydrogen; 7=gas-impermeable separator.

FIG. 3 shows an embodiment of the present invention with multiple porous matrix materials. One, two, three or more porous matrix materials could be positioned at any location A, B or C on the condition that at least one porous matrix material is present at location B. 1=gas entry; 2=porous matrix material; 3=oxygen producing electrode; 4=hydrogen producing electrode; 5=connection to a power source; 6=outlet for the produced hydrogen.

FIG. 4 shows an embodiment of the present invention with a gas-impermeable separator and with multiple matrix materials. One, two, three, four or more porous matrix materials could be positioned at any location A, B, C or D. 1=gas entry; 2=porous matrix material; 3=oxygen producing electrode; 4=hydrogen producing electrode; 5=connection to a power source; 6=outlet for the produced hydrogen.

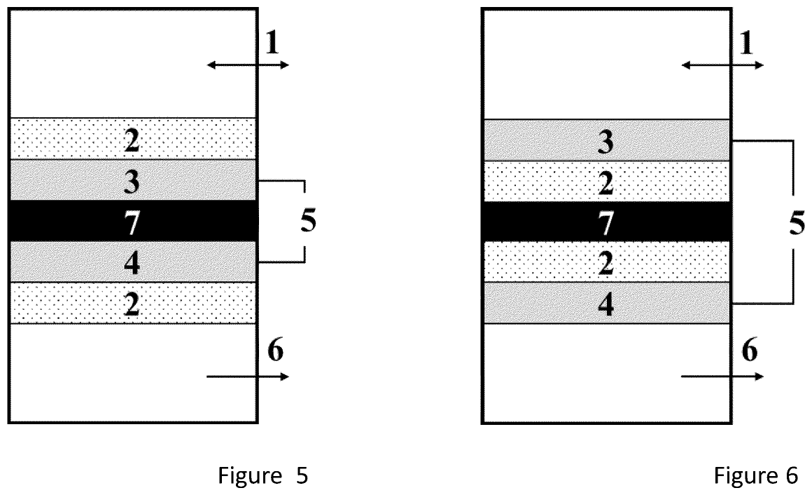

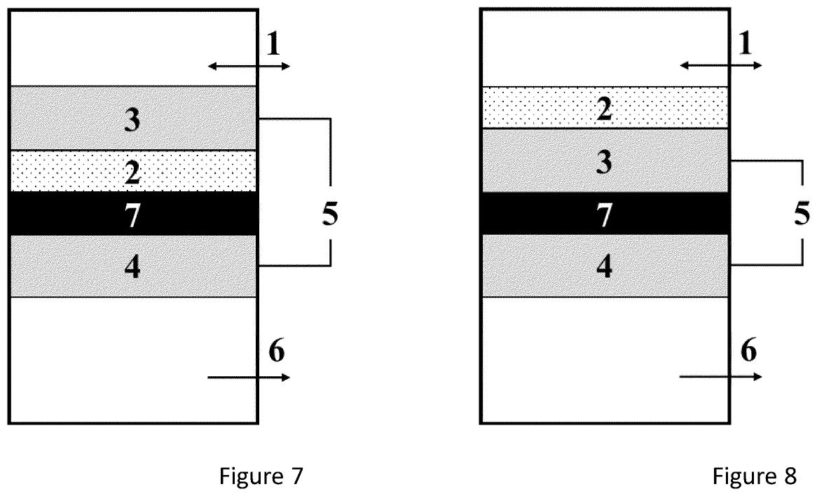

FIGS. 5 to 8 show furthers embodiment of the present invention. 1=gas entry; 2=porous matrix material; 3=oxygen producing electrode; 4=hydrogen producing electrode; 5=connection to a power source; 6=outlet for the produced hydrogen.

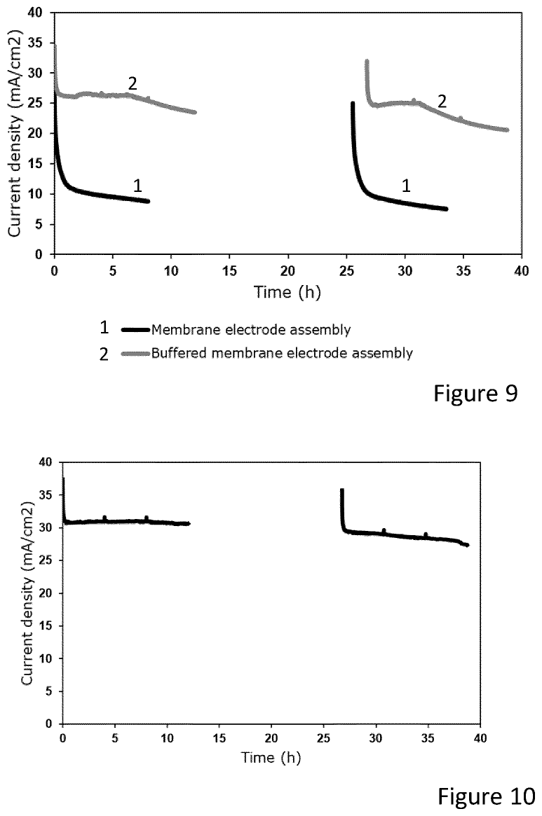

FIG. 9 shows the experiment described in Example 1, in which two-electrode vapor-fed water splitting was performed at a fixed potential of 1.8 V. After a period of hydrogen production, a period without applied potential was allowed for the devices to regenerate. Two distinct devices were tested (with and without a porous matrix material), and their resulting current density is shown.

FIG. 10 shows the experiment described in Example 2, in which two-electrode vapor-fed water splitting was performed at a fixed potential of 1.8 V. After a period of hydrogen production, a period without applied potential was allowed for the device to regenerate. A device containing a porous matrix material and a commercial gas-impermeable separator was tested, and the resulting current density is shown.

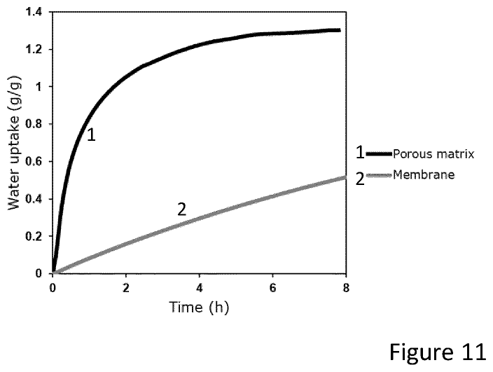

FIG. 11 shows the experiment described in Example 3, in which water uptake was measured over time when exposed to a humid gas stream. Two materials were tested, one being a porous matrix material and another being a membrane material.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to the devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Hygroscopic, as used herein, refers to a hygroscopic material is a material which readily absorbs or adsorbs water molecules from a gas containing such molecules, i.e. able to take up at least 0.1 g water per g of material compared to its fully dried state, after 24 h under optimal conditions at room temperature (100% RH, high gas flow rate, minimal amount of material).

Deliquescent and a deliquescent material is a material which, as a solid, when exposed to humid gas absorbs an amount of water that is sufficient to dissolve said solid into a viscous or liquid solution.

Thickness When reference is made to the thickness of a planar porous matrix material, a membrane or a separator, the minimum width of the material is meant perpendicular to the materials' largest surface. Materials may be irregular in width. When two materials of the same type (e.g. two porous matrix materials) are positioned immediately next to or on top of each other, ‘thickness’ refers to the combined thickness of both materials.

Porous or porous material as used herein refers to a material with an average pore size of at least 0.4 nm in diameter, up to 5 mm in diameter. The pores may be ordered or otherwise non-ordered and irregular. The pores could be of varying shape and size. Pores could be present inside a material (e.g. a crystalline porous material), or be present in the voids between porous or non-porous particles or molecules (e.g. crystallites, fibres or polymer chains).

Macroporous, as used herein refers, to a porous material with an average pore size of at least 50 nm in diameter.

Matrix, as used herein, refers to a material able to contain another material in its structure, such as a liquid or a salt.

A power source as used herein refers to any connection or device able to provide electrical power.

Electrode as used herein refers a surface onto which electrochemical reactions occur. The electrode could be of a single material, or could be composed of several layers or materials (e.g. containing current collectors or electrocatalysts). When the device contains electrically conductive or catalytically active elements serving as a water capturing material or a porous matrix material, these elements are not considered to be part of the electrode.

Separator, as used herein, refers to a material which is sufficiently impermeable to gases (permeability of hydrogen and oxygen less than 10⁻⁶ mol·m⁻²·s⁻¹) so as to prevent unsafe operation of an electrolysis device.

Membrane, as used herein, refers to a polymeric separator which is either non-porous or otherwise with pores that have an average diameter of less than 10 nm. It may or may not contain fixed ionic charges. It may be an anion exchange membrane or a cation exchange membrane.

Electrolyte, an used herein, refers to a medium able to transport ions (conductivity of at least 0.1 S·m⁻¹). It could be a solid electrolyte (e.g. a membrane with fixed ionic groups) or a liquid electrolyte (e.g. an aqueous solution containing a salt).

Solute, as used herein, refers to any acid, base or salt having the potential to be dissolved (at least 10 g/L at room temperature) in aqueous solution.

Assembly, as used herein, refers to a unit defined by an outer layer of a hydrogen producing electrode and an outer layer of an oxygen producing electrode, and in between these electrode at least one layer of porous matrix material or at least one layer of a gas-impermeable separator, such that both electrodes are not in direct contact with each other.

Embodiments of assemblies are a Membrane electrode assembly (MEA): A composition of at least one separator and two electrodes for water electrolysis and a Buffered membrane electrode assembly (BMEA): A composition of at least one porous matrix material and two electrodes for water electrolysis.

Gas inlet, as used herein, refers to an opening providing access of gas to an enclosed volume. The opening may be of circular, slit-like, rectangular or other shape. For example a gas entry can be achieved by partially or completely opening the enclosed volume. It may be as large as half of the outer surface area of the enclosed volume to which it provides access. The opening and closing of the gas inlet can be controlled by moisture sensing devices or light sensing devices allowing to close the inlet when the feed gas is too dry. The gas inlet provides access to the environment outside of the device, which may be ambient air or otherwise a pipe or other connection containing a humid gas stream, or any other means of providing a feed gas to the device. The gas inlet may also serve as a gas outlet.

Gas outlet, as used herein, refers to an opening in an enclosed volume allowing controlled removal of the gas from such volume. The gas outlet can be fitted with a pressure valve or non-return valve which opens when a certain amount of hydrogen or oxygen has been built up.

“between the oxygen producing and hydrogen producing electrode” with respect to the separator refers to the relative localization of the separator. The separator can be in direct contact with both electrodes. Alternatively porous matrix material can be present between oxygen producing electrode and the separator and/or porous matrix material can be present between the hydrogen producing electrode and the separator.

“Positioned” with respect to the porous matrix material refers to the location of the material between two of the elements of the apparatus. With exception of the positioning between the inlet and the oxygen producing electrode and the positioning between the hydrogen producing electrode and the outlet, this refers to being in contact with both neighboring elements.

Thus a matrix material positioned between electrode (3) and separator (7) is in contact at one side with the electrode and at the other side in contact with the separator.

In contact with with respect to the porous matrix material (2) and the oxygen producing electrode (3) means that the porous matrix material (2) is immediately adjacent to the oxygen producing electrode at one side, or at two side whereby the electrode is sandwiched between the two matrix materials.

The present invention relates to the field of water vapour electrolysis and solar-driven water vapour electrolysis. Such devices are advantageous compared to liquid-based systems as they require less peripheral equipment, consume no liquid water and are less prone to catalyst instability. However, in the art it is acknowledged that water management is a critical issue in such devices. In order to closely match water supply and consumption, it is required to utilize inlet feeds with high flow rates and high relative humidity. Slight mismatches rapidly result in (localized) dehydration and a strong performance drop. The present invention circumvents these problems by incorporating a porous matrix material able to capture, store, transmit and release liquid water directly to the system when necessary, obviating the need for continuous and immediate matching of supply and consumption of water molecules. The porous matrix material is in direct contact with the other active components of the assembly, such as catalysts and a separator (if any). All components including the porous matrix material, catalyst layer and separator (if any) are permeable to water. This assembly ensures fast water transport, both during operation and during regeneration of the assembly.

In one embodiment, the porous matrix material contains a solution which contains a solute. The liquid continuum ensures impermeability to gaseous products and the porous matrix material in this case acts as a separator between both electrodes. To improve gas tightness, a porous matrix material may be back-filled with a second porous matrix material or coated with a polymer or other material, to reduce pore size and facilitate the formation of a liquid continuum, maintained by capillary forces. In another embodiment, additional porous matrix materials may be added at the outer side of the assembly, to further tune the water storage and transport capacities of the assembly. These additional porous matrix materials need not contain a continuous liquid phase, as they need not serve the function of separator.

In another embodiment, a gas-impermeable separator is positioned in between the electrodes, serving the function of preventing gas cross-over. In this case, none of the porous matrix materials needs to contain a continuous liquid phase. Such assembly may contain one, two, three or four porous matrix materials at various locations in the assembly. The separator may be a membrane, such as a classical homogeneous ion exchange membrane.

The assembly contained in an enclosed volume or chamber shall be used to produce hydrogen and oxygen from a source of water vapour and a source of electrical power. When a photovoltaic or other solar-driven device is utilized to provide such power, a solar hydrogen production unit may be obtained. The use of water vapour is particularly advantageous in this case, as it allows for a stand-alone and autonomous operation of the device without artificial inputs.

In a specific embodiment, the porous matrix material is a material with ion-conducting properties and a solute is added which is targeted to have high water uptake capacity. In yet another embodiment, the porous matrix material is a material with high water uptake capacity and a solute is added which is targeted to have ion-conducting properties. In yet another embodiment, the porous matrix material is a metallic material, able to conduct electric charge from and towards the electrodes or to the catalyst. In yet another embodiment, the porous matrix material is a composite material containing particles with enhanced water sorption properties, such as mesoporous silica or metal-organic framework.

The proposed system may be designed to have high, low, or intermediate pH. The solute will determine the operational pH of the system. The porous matrix material or the separator may be a cation exchange material or an anion exchange material. A combination of such materials could be employed to obtain a bipolar system. When ion-selective materials are used, it is possible to operate the hydrogen producing electrode and the oxygen producing electrode at different pH. It is possible to tune the porous matrix material based on the local climate or the desired level of autonomy. When the thickness of the porous matrix material is increased, more water can be stored. The porous matrix material preferably has a thickness of at least 50, 100, 200, 300, 400 or 500 μm. When multiple porous matrix materials are used, the thickness of each porous matrix material can be accordingly reduced. When the solute is changed, a different level of water uptake can be achieved. Furthermore, a material may be chosen with a water sorption isotherm favouring water adsorption or desorption at low, intermediate or high relative humidity.

The present invention is advantageous for devices receiving a continuous inlet feed of water vapour. Since, even when power supply is fluctuating and water consumption is not constant, the stored water inside the porous matrix material stabilizes the availability of water. In another embodiment, the device does not receive a continuous inlet feed but is regenerated only when outside relative humidity is high (e.g. during night-time). In this case, the porous matrix material is particularly advantageous since it may store enough water for a full day of operation. In another embodiment, the porous matrix material stores water for multiple days of autonomous operation. This is advantageous in regions with multiple subsequent days and nights having low outside relative humidity.

The system may be fed with a pump or a ventilator. It may also be fed with a pipe or tube coming from a pressurized process providing steam or vapour. It may also be regenerated or fed by natural convection, when the device is placed outside. The system may be conceived to float above a freshwater surface or above seawater, so as to enhance the supply of air with high relative humidity.

### EXAMPLES

### Example 1: Vapor Phase Water Splitting with and without a Porous Matrix Material

A device was built using the possible embodiments of the invention. A membrane electrode assembly was inserted into a reaction chamber, consisting of nickel-based anode and cathode and a polyvinyl alcohol based ion-solvating membrane. The membrane was impregnated with a 4 M solution of potassium hydroxide. In a second experiment, a polyvinyl alcohol porous matrix material was included on either side of the membrane to obtain a buffered membrane electrode assembly. The active surface area of the assemblies was 4 cm². In both instances, a constant potential of 1.8 V was applied in two-electrode mode. After 8 h and 12 h of operation, respectively, the devices were allowed 17 h and 14 h to regenerate, respectively. During the whole experiment, the devices were fed with 52.5 ml/min of nitrogen gas at 95% relative humidity through the anode compartment. FIG. 9 shows that a higher and more consistent water splitting current is achieved when a porous matrix material is present, even when the device was operated longer and had a shorter timeframe to regenerate.

### Example 2: Vapor Phase Water Splitting with a Commercial Anion Exchange Membrane

A device was built using the possible embodiments of the invention. A buffered membrane electrode assembly was inserted into a reaction chamber, consisting of nickel-based anode and cathode and a FAD-PET-75 homogeneous anion exchange membrane. A polyvinyl alcohol porous matrix material was included on either side of the membrane. The porous matrix material was impregnated with a 4 M solution of potassium hydroxide. The active surface area of the assembly was 4 cm². A constant potential of 1.8 V was applied in two-electrode mode. After 12 h of operation, simulating a full day of solar-driven electrolysis, the device was allowed 14 h to regenerate. During the whole experiment, the devices were fed with 52.5 ml/min of nitrogen gas at 95% relative humidity through the anode compartment. FIG. 10 shows that, in presence of a porous matrix material, good performance is achieved since a current density of well above 10 mA/cm² can be sustained for 12 h.

### Example 3: Water Uptake of Porous Matrix Material

Water uptake experiments were performed with a climate-controlled precision balance. Dense polyvinyl alcohol membrane and polyvinyl alcohol porous matrix material were both impregnated with a solution of 4 M KOH overnight. After removal of excess liquid, these were tested in the balance. FIG. 11 shows the mass-normalized water uptake over time. It clearly demonstrates that a porous matrix material allows for much faster water uptake and transport.

1-23. (canceled)

24. A hydrogen producing apparatus comprising an enclosed volume, wherein the enclosed volume comprises:
at least one gas inlet from outside the enclosed volume;
an assembly comprising:
at least one layer of a porous matrix material with hygroscopic or deliquescent properties and having ionic conductivity; and
an oxygen producing electrode and a hydrogen producing electrode, positioned on opposite sides of a layer of the porous matrix material or on opposite sides of a gas-impermeable separator;
connections for connecting the oxygen producing electrode and the hydrogen producing electrode to a power source; and
at least one outlet for hydrogen produced by the hydrogen producing electrode.

25. The hydrogen producing apparatus according to claim 24, wherein the oxygen producing electrode and the hydrogen producing electrode are positioned on opposite sides of a layer of the porous matrix material.

26. The hydrogen producing apparatus according to claim 25, wherein in addition a further porous matrix material is positioned at one or both outer sides of the assembly.

27. The hydrogen producing apparatus according to claim 24, wherein the assembly comprises a gas-impermeable separator and the oxygen producing electrode and the hydrogen producing electrode are positioned on opposite sides of the gas-impermeable separator.

28. The hydrogen producing apparatus according to claim 27, comprising a layer of the porous matrix material positioned at one or both outer sides of the assembly.

29. The hydrogen producing apparatus according to claim 27, comprising a first layer of the porous matrix material positioned between the gas-impermeable separator and the oxygen producing electrode and/or a second layer of the porous matrix material positioned between the gas-impermeable separator and the hydrogen producing electrode.

30. The hydrogen producing apparatus according to claim 27, further comprising an additional layer of the porous matrix material positioned at one or both outer sides of the assembly.

31. The hydrogen producing apparatus according to claim 24, wherein the gas-impermeable separator is a membrane.

32. The hydrogen producing apparatus according to 24, wherein the porous matrix material comprises one or more solutes providing hygroscopic, deliquescent, and/or conductive properties.

33. The hydrogen producing apparatus according to claim 24, wherein the oxygen producing electrode and the hydrogen producing electrode are connected directly to a device for solar energy conversion.

34. The hydrogen producing apparatus according to claim 33, wherein the device for solar energy conversion is a photovoltaic device or a photoelectrochemical device.

35. The hydrogen producing apparatus according to claim 24, wherein the porous matrix material contains pores having a diameter of at least 10 nm.

36. The hydrogen producing apparatus according to claim 24, wherein the porous matrix material has a thickness of at least 300 μm.

37. The hydrogen producing apparatus according to claim 24, wherein the porous matrix material contains a hydrophilic polymer and a solute that provides an ionic conductivity of at least 0.1 Siemens/m.

38. A method of producing hydrogen in the hydrogen producing apparatus according to claim 24, the method comprising:
allowing the entrance of an inlet gas comprising water into the enclosed volume via the gas inlet, thereby regenerating the water content of the porous matrix material; and
allowing conversion of electrical energy and water molecules into hydrogen and oxygen molecules on the hydrogen producing electrode and the oxygen producing electrode, respectively.

39. The method of claim 38, further comprising closing the gas inlet after the water content of the porous matrix material is regenerated.

40. The method according to claim 38, wherein the gas inlet is openable and closable by a light-sensitive sensor operating according to a diurnal cycle or by a humidity-dependent sensor.
